(19) United States
(12) Patent Application Publication
(10) Pub. No.: US 2022/0084080 A1
(43) Pub. Date: Mar. 17, 2022

(54) METHOD AND SYSTEM FOR EVALUATING VEHICLE RESALE VALUE

(71) Applicant: FORD GLOBAL TECHNOLOGIES, LLC, Dearborn, MI (US)

(72) Inventors: Abraham MEZAAEL, Southfield, MI (US); Colleen HUMMEL, Northville, MI (US)

(73) Assignee: FORD GLOBAL TECHNOLOGIES, LLC, Dearborn, MI (US)

(21) Appl. No.: 17/023,705

(22) Filed: Sep. 17, 2020

(51) Int. Cl. G06Q 30/02; G07C 5/00

(52) U.S. Cl. CPC G06Q 30/0278; G07C 5/006; G06Q 30/0283

(57) ABSTRACT

A server includes a hardware processor configured to: responsive to receiving a diagnostic trouble code (DTC) from a vehicle via a computer network, analyze the DTC to calculate a first price deduction for the vehicle caused by the DTC; calculate a base price for the vehicle using vehicle information reflecting vehicle make, model, year, and mileage; and calculate a resale price for the vehicle using the base price and the first price deduction.

### TECHNICAL FIELD

The present disclosure generally relates to a system for evaluating vehicle resale value. More specifically, the present disclosure relates to a system for evaluating vehicle resale value using diagnostic trouble codes (DTCs).

### BACKGROUND

In modern vehicle architecture, DTCs are used to inform about vehicle module condition, troubles and failures. The DTCs may be read via a scan tool through a connecting port, e.g. an on-board diagnostic II (OBD-II) port. DTCs may be divide multiple types to cover a variety range of conditions. The conditions may range from critical conditions requiring immediate attention to minor condition feedback which can be ignored in some cases.

### SUMMARY

In one or more illustrative embodiments of the present disclosure, a server includes a hardware processor configured to: responsive to receiving a diagnostic trouble code (DTC) from a vehicle via a computer network, analyze the DTC to calculate a first price deduction for the vehicle caused by the DTC; calculate a base price for the vehicle using vehicle information reflecting vehicle make, model, year, and mileage; and calculate a resale price for the vehicle using the base price and the first price deduction.

In one or more illustrative embodiments of the present disclosure, a method for a server includes responsive to receiving a first user input via a user device indicative of an intent to service the vehicle to remove a diagnostic trouble code (DTC), analyzing the DTC to identify a cause for the DTC; identifying replacement parts to repair the cause; calculating a repair estimate by obtaining a price for the replacement parts and labor cost for the repair from a database; and sending the repair estimate to the user device.

In one or more illustrative embodiments of the present disclosure, a non-transitory computer-readable medium includes instructions, when executed by a computer device, make the computer device to: output a first interface via a display, wherein the interface includes an identification for a vehicle, a current resale price for the vehicle, and a diagnostic trouble code (DTC) currently associated with the vehicle, and an improved resale price for the vehicle under the condition that the DTC is removed.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example blockchain topology diagram of one embodiment of the present disclosure;

FIG. 3 illustrates an example flow diagram for a process of one embodiment of the present disclosure;

FIG. 4 illustrates an example flow diagram of a process of another embodiment of the present disclosure; and

FIG. 5 illustrates an example diagram of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle resale value evaluation system. Different DTCs may affect a resale value of the vehicle. Accordingly, the present disclosure proposes a system for evaluating vehicle resale value based on various vehicle conditions including the presence of one or more DTCs.

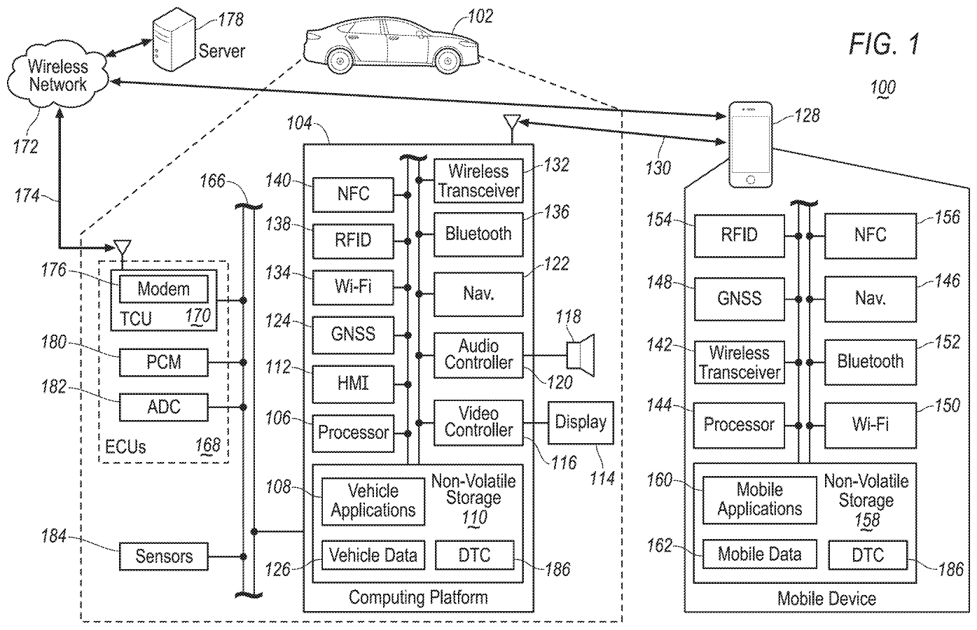

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), or a parallel/series hybrid vehicle (PSHEV), a boat, a plane or other mobile machine for transporting people or goods. As an example, the system 100 may include the SYNC system manufactured by The Ford Motor Company of Dearborn, Mich. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants/users to interface with the computing platform 104. For example, the computing platform 104 may receive input from HMI controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, a ultra-wide band (UWB) controller (not shown), and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a navigation controller 146 and a GNSS controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, UWB, or the like.

The computing platform 104 may be configured to communicate with various ECUs 168 of the vehicle 102 configured to perform various operations. For instance, the computing platform 104 may be configured to communicate with a TCU 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle may access one or more servers 178 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 168 may further include a powertrain control module (PCM) 180 configured to operate powertrain of the vehicle 102. For instance, the PCM 180 may be configured to start the vehicle responsive to receiving a command from the mobile device 128 via the TCU 170. The ECUs 168 may further include an autonomous driving controller (ADC) 182 configured to control an autonomous driving feature of the vehicle 102. Driving instructions may be received remotely from the server 178. The ADC 182 may be configured to perform the autonomous driving features using the driving instructions combined with navigation instructions from the navigation controller 122. Each ECU 168 may be provided with or connected to one or more sensors providing signals related to the operation of the specific ECU 168. For instance, The PCM 180 may be connected to a vehicle speed sensor 184 configured to provide signals of a driving speed of the vehicle, and one or more engine sensors 184 configured to monitor engine operation and provide sensing data such as ignition timing. Each ECU 168 may be provided with diagnostics features and configured to generate DTCs responsive to detecting a predefined condition. For instance, the PCM 180 may be configured to generate a P0300 DTC responsive to detecting an engine misfire via the engine sensor 184. The DTCs 186 generated may be stored in the respective ECU 168 provided with storage capability. Additionally, the ECUs 168 may be further configured to report the DTCs 186 to the computing platform 104 via the in-vehicle network 166 for central storage. DTCs 186 generated by various ECUs 168 may be collectively stored in the storage 110 before being uploaded to the server 178 (to be discussed in detail below). The computing platform 104 may be configured to send the DTCs 186 to the mobile device 128 for storage and reporting.

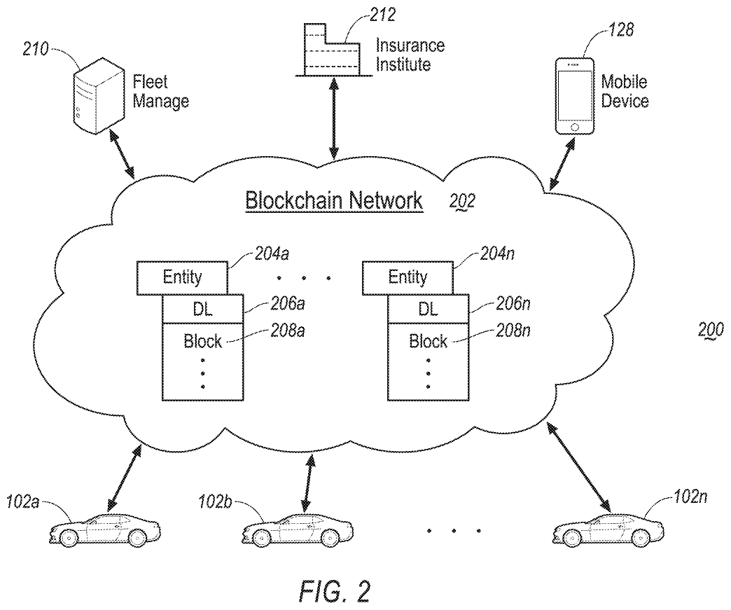

In one embodiment, the vehicle DTC reporting of the present disclosure may be implemented as a blockchain network. Referring to FIG. 2, an example topology diagram 200 of a vehicle blockchain network 202 of one embodiment of the present disclosure is illustrated. The vehicle blockchain network 202 may be a peer-to-peer network having multiple entities 204 connected with each other. Each entity 204 may serve as a node of the blockchain network 202 and be configured to store and maintain a distributed ledger (DL) 206. For instance, the entities 204 may include a variety of devices (e.g. servers, computers, storage medium) associated with multiple parties contracted with the blockchain network 202. Each distributed ledger 206 that is maintained by each node of the blockchain network 202 may include multiple data blocks 208 for data logging purposes. There may be multiple vehicles 102 connected to the blockchain network 202. With continuing reference to FIG. 1, A vehicle 102a may be configured to upload the DTC 186 generated by the ECUs 168 to the blockchain network 202 via the TCU 170. Additionally or alternatively, the vehicle 102a may upload the DTC 186 via the associated mobile device 128. Once uploaded, the DTC 186 is distributed throughout the blockchain network 202 and converted into blocks 208 for storage in multiple distributed ledgers 206. Each distributed ledger 206 may grow at a block-by-block basis. For instance, a successor block may contain a cryptographic hash of a predecessor block, a timestamp indicative of a time of creation of the successor block, as well as other transaction data. A miner (a.k.a. validator, not shown) may be used to validate each transaction between nodes. It is noted that the DTC 186 is merely used as an example here and the blockchain network 202 may be configured to store and maintain other types of data related to the resale value of each vehicle 102. For instance, the blockchain network 202 may be configured to maintain data related to vehicle insurance, accident record, vehicle features, vehicle identifications, vehicle maintenance record or the like.

Multiple parties may be configured to access the data stored in the blockchain network 202 for various purposes. For instance, a fleet manager 210 may be connected to the blockchain network 202. The fleet manager 210 may be provided with data analytics capability using a smart contract configured to perform analysis for the data stored in the blockchain network 202 and evaluate a resale value based on the analysis. The resale value information may be provided to one or more mobile devices 128 which is also connected to the blockchain network 202. Alternatively, the resale value information may be provided to the mobile device 128 via other network without going through the blockchain network 202. Other entities connected to the blockchain network may include an insurance institutes which manage and record insurance related information (e.g. accident, claims or the like) via the blockchain network 202.

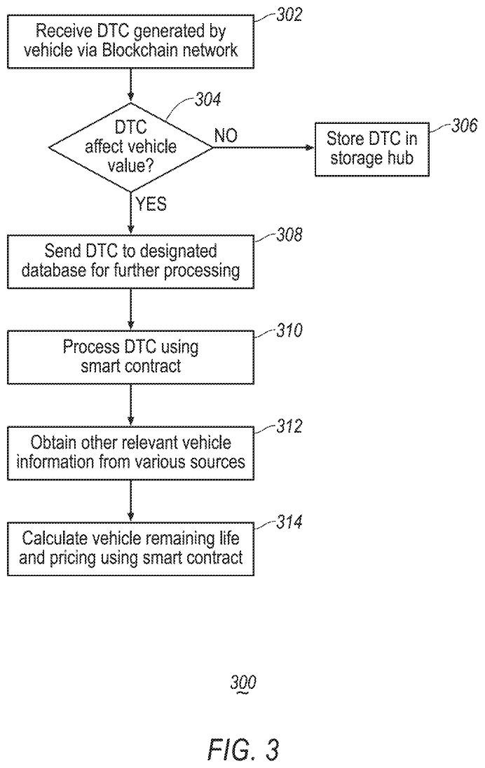

Referring to FIG. 3, an example flow diagram for a process 300 of one embodiment of the present disclosure is illustrated. With continuing reference to FIGS. 1 and 2, at operation 302 a server 178 receives a DTC 186 generated by the vehicle 102 via the blockchain network 202. For instance, the server 178 may be associated with the fleet manager 210 provided with data analytics capability to coordinate the process. As discussed previously with reference to FIG. 2, the vehicle 102 may generate the DTC 186 and upload the DTC 186 to the blockchain network 202 for storage. At operation 304, the server 178 evaluates if the DTC 186 is classified as being relevant to the vehicle resale value. For instance, the DTC 186 may be generally classified as being relevant to the vehicle resale value such as P0300 engine misfiring which requires a service, or as being irrelevant to the resale value such as B13A9 glove compartment lamp fault which generally does not affect the normal using of the vehicle and can be ignored. If the server 178 determines the DTC 186 is within the class that is irrelevant to the vehicle resale value, the process proceeds to operation 306 and the server 178 stores the DTC 186 in a storage hub for data recordation and takes no further actions. The storage hub may be a database associated with the server 178 and independent from the blockchain network 202. Alternatively, the server 178 may leave the DTC 186 stored in the blockchain network 202 without storing the DTC 186 in the storage hub.

If the server 178 determines that the DTC 186 is within the class that is relevant to the vehicle resale value, the process proceeds from operation 304 to operation 308, and DTC 186 is sent to a designated database for further processing. The designated databased may be separated from the storage hub and configured to store DTCs to be analyzed. At operation 310, the server 178 processes the DTC 186 using a smart contract to evaluate the potential issue of the vehicle related to the DTC 186. At operation 312, the server 178 obtains other vehicle information related to the vehicle resale value to further evaluate the vehicle resale value. As an example, the relevant vehicle information may include vehicle odometer value from the vehicle 102, vehicle insurance claims from the insurance institute 212, vehicle service history from dealers, vehicle features or the like. With all the information obtained, at operation 314, the server 178 calculates the vehicle remaining life and resale value based on the vehicle information and DTC 186. As an example, the server 178 may calculate a base price for the vehicle 102 based on relevant vehicle information obtained at operation 312 and then use the DTC 186 as a price adjustment factor to calculate the final resale value. Each DTC may be assigned with a price adjustment/deduction value. The price adjustment may be a fixed value for the specific vehicle. As an example, P0300 engine misfire may be assigned with a $2,000 deduction for the vehicle 102 given the make, model, and year of the vehicle. Alternatively, the price adjustment may be a variable value based on historical DTC and service history for the vehicle 102. For instance, if the same DTC repeatedly occurs after services at the dealer, the reoccurrence may indicate that the same DTC may be caused by more serious trouble which requires further and more expensive repair. In this case, the smart contract may increase the price detection as an accommodation for the potential more serious issue. Taking the above P0300 code for engine misfire for example, if it is the first time that the P0300 code occurs, the vehicle 102 may just need an engine tune-up and a fixed price deduction of $2,000 may be assigned. However, if the same code continues to occur after the vehicle 102 has been serviced, it may indicate more serious issues with the vehicle (e.g. control module, internal engine damage or the like). The price deduction may be increased to $3,000 USD accordingly to correspond to this potential more serious issue.

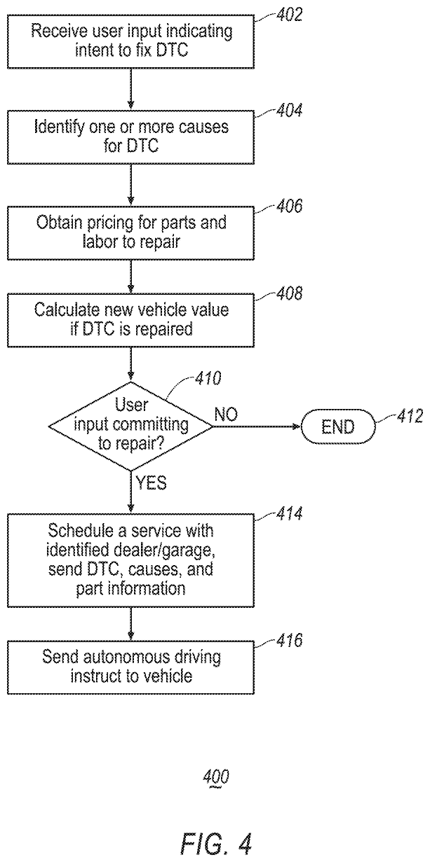

Referring to FIG. 4, a flow diagram for a process 400 of another embodiment of the present disclosure is illustrated. The process 400 applies to a situation in which the vehicle resale value is presented to the vehicle user and the user may be further provided with options to repair the DTC to increase the vehicle resale value. At operation 402, the server 178 receives a user input indicative of the user intent to repair the vehicle to remove the DTC 186 and increase the resale value of the vehicle 102. Responsive to receiving a user input indicative of an intent to repair a selected DTC 186 at operation 402, the server identifies one or more causes for the DTC 186 at operation 404. Since a given DTC may commonly correspond to one or more causes, a databased may be used to identify possible causes for each DTC. Additionally or alternatively, the server 178 may be configured to dynamically diagnose the cause of the DTC based on other vehicle information previously obtained (e.g. maintenance record) to find more probably causes for the DTC. Responsive to identifying one or more causes for the DTC 186, at operation 406, the server 178 obtains pricing for parts and labor to address the causes. Since more than one causes may be identified, the pricing for parts and labor may be presented in the form of a pricing range from the minimum to the maximum price for the repair. At operation 408, the server calculates a new vehicle price for the vehicle 102 after having the DTC 186 addressed which is likely higher than the original price. Both the repair cost and new price may be provided to the vehicle user to help decide whether to fix the DTC 186 or not. If the user decides not to fix the DTC 186 the process proceeds from operation 410 to operation 412 without further actions. Otherwise, if the user decides to repair the DTC 186, the process proceeds to operation 414 and the server 178 schedules a service with a dealer/garage identified by the user. Additionally, the server 178 sends the DTC, the identified cause, and the parts information to the dealer/garage to have the technician prepared and parts ready when the vehicle 102 arrives. At operation 416, the server 178 generates and sends an autonomous driving instruction to the vehicle 102 to drive to the dealership to perform the scheduled service.

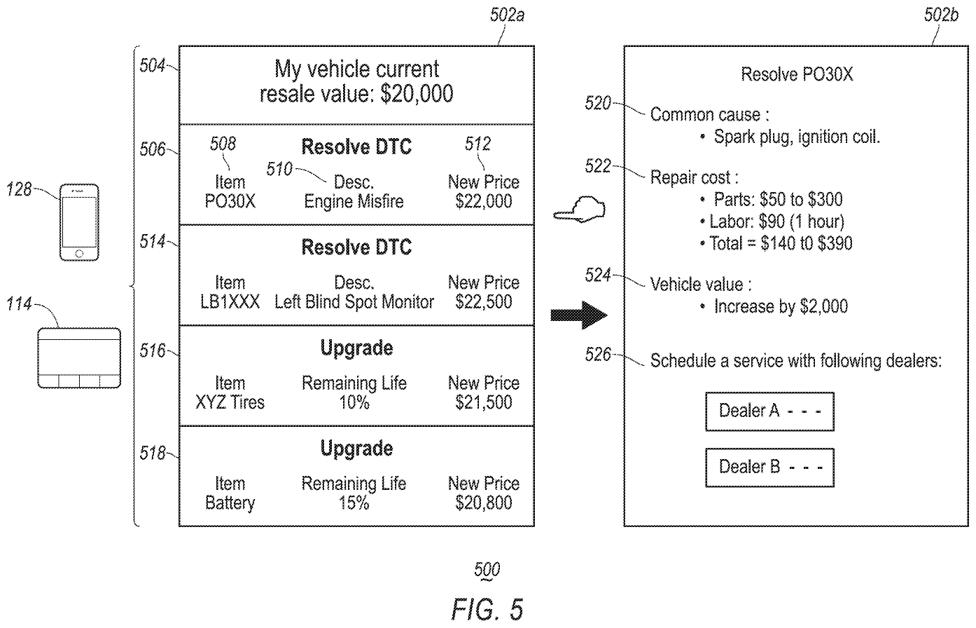

The operations of process 400 may be applied to various situations. Referring to FIG. 5, an example interface diagram 500 of one embodiment of the present disclosure is illustrated. With continuing reference to FIGS. 1 to 4, an interface 502a may be provided to offer the vehicle user with options to enhance the resale value of the vehicle 102. The interface 502a may be provided via the mobile device 128 using the mobile application 160. Additionally or alternatively, the interface 502a may be provided via the display 114 through the HMI controls 112 of the vehicle 102. The interface 502a may be triggered responsive to a user input indicative of an intent to evaluate the resale value of the vehicle 102. The interface 502a may include a header section 504 to identify the vehicle 102 as associated with the user and a current resale value of the vehicle 102. As illustrated in the present example, the current resale value for the vehicle 102 is $20,000. The interface 502a may be configured to provide options to increase the resale value based on the specific condition of the vehicle 102. For instance, if the vehicle 102 currently has an outstanding DTC that is yet to be addressed, the interface 502a may provide the user with an option to repair the issue causing the DTC to increase the resale value of the vehicle 102. In the present example the vehicle 102 may have two outstanding DTCs illustrated in sections 506 and 514 respectively. Taking section 506 for instance, a code P030X may be listed in the item segment 508, followed by a description segment 510 briefly describing the meaning of the code. A new price segment 512 may be displace alongside other segments in section 506 to indicate an estimated price for the vehicle 102 with the corresponding DTC fixed. In the example illustrated in section 506, the new price is $22,000 if the P030X engine misfire code is addressed. The new price may be calculated in operations discussed above. In addition to providing options to resolve DTCs, the interface 502a may be further configured to provide the user with options to upgrade the vehicle to further increase the resale value price. For instance, the interface 502a may provide upgrade option in sections 516 and 518. Similar to section 506 described above, the upgrade sections may include the same or similar segments for item, descriptions and new price. For instance, section 516 may provide an option to upgrade vehicle tires to increase the resale value. A current remaining tire life of 10% may be displayed in the section. The remaining life may be measured via a tire tread sensor (if provided to the vehicle). Alternatively, the remaining life of the tires may be measured by a technician during a previous service and reported to the server 178. As an example, the remaining life of the tires may be reported to the server 178 via the blockchain network 202.

The interface 502a may be configured to invite the user to interact with the interface 502 by providing an input selecting one or more options as listed. For instance, responsive to receiving a user touch input selecting section 506, the interface 502a may bring the user to the next page 502b to proceed with the resolution. As illustrated, the interface 502b may display a common cause 520 corresponding to the DTC 508. Additionally, a repair cost 522 may be provided. The repair cost 522 may include both parts and labor cost obtained via the network to provide the user with a range of total repair cost estimation. In the present example, the common causes for the P030X code may involve a bad spark plug, and/or an ignition coil. Parts for repair may cost $50 to $300 plus $90 labor cost, making the total cost ranging from $140 to $390. The interface 502b may further include a vehicle value section indicative of an improved vehicle value based on the condition that the currently selected DTC is address. In this case, there will be $2,000 increase for the estimated resale value for the vehicle 102. The interface 502b may further include options allowing the user to directly schedule an appointment 526 with the dealer without needing to go elsewhere. The user may schedule an appointment by selection one of the dealer options to proceed with the service.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A server, comprising a hardware processor, configured to:
responsive to receiving a diagnostic trouble code (DTC) from a vehicle via a computer network, analyze the DTC to calculate a first price deduction for the vehicle caused by the DTC;
calculate a base price for the vehicle using vehicle information reflecting vehicle make, model, year, and mileage; and
calculate a resale price for the vehicle using the base price and the first price deduction.

2. The server of claim 1, wherein the processor is further configured to:
responsive to receiving a first user input via a user device indicative of an intent to service the vehicle to remove the DTC, identify a cause for the DTC and replacement parts to repair the cause.

3. The server of claim 2, wherein the processor is further configured to:
calculate a repair estimate by obtaining a price for the replacement parts and labor cost for the repair from a database; and
send the repair estimate to the user device.

4. The server of claim 3, wherein the processor is further configured to:
responsive to receiving a second user input via the user device indicative of a confirmation to service the vehicle, schedule an appointment with a service entity associated with the user and send the DTC to the service entity.

5. The server of claim 4, wherein the processor is further configured to:
send information related to the cause and replacement parts to the service entity.

6. The server of claim 4, wherein the processor is further configured to:
responsive to detecting a reoccurrence of the same DTC after the vehicle has been serviced by the service entity, recalculate a second price deduction for the vehicle caused by the DTC, wherein the second price deduction is greater than the first price deduction.

7. The server of claim 4, wherein the processor is further configured to:
generate an autonomous driving instruction to direct the vehicle to drive to the service entity at a time of the appointment.

8. The server of claim 1, wherein the computer network is a blockchain network.

9. The server of claim 1, wherein the processor is further configured to:
verify a classification of the DTC; and
responsive to verifying the DTC is of a class unrelated to the resale price, store the DTC in a storage hub.

10. A method for a server, comprising:
responsive to receiving a first user input via a user device indicative of an intent to service the vehicle to remove a diagnostic trouble code (DTC), analyzing the DTC to identify a cause for the DTC;
identifying replacement parts to repair the cause;
calculating a repair estimate by obtaining a price for the replacement parts and labor cost for the repair from a database; and
sending the repair estimate to the user device.

11. The method of claim 10, further comprising:
responsive to receiving a second user input via the user device indicative of a confirmation to service the vehicle, outputting a plurality of service entities to perform the service; and
responsive to receiving a user selection for one of the service entities, scheduling an appointment with the selected service entity and send the DTC to the service entity.

12. The method of claim 11, further comprising:
sending information related to the cause and replacement parts to the selected service entity.

13. The method of claim 10, further comprising:
responsive to receiving the DTC from the vehicle via a computer network, analyzing the DTC to calculate a first price deduction for the vehicle caused by the DTC;
calculating a base price for the vehicle using vehicle information reflecting vehicle make, model, year, mileage and features;
calculating a resale price for the vehicle using the base price and first price deduction; and
sending the first price deduction to the user device.

14. The method of claim 13, further comprising:
responsive to detecting a reoccurrence of the same DTC after the vehicle has been serviced by the selected service entity, recalculating a second price deduction for the vehicle caused by the DTC, wherein the second price deduction is greater than the first price deduction.

15. The method of claim 13, wherein the computer network is a blockchain network.

16. A non-transitory computer-readable medium, comprising instructions, when executed by a computer device, make the computer device to:
output a first interface via a display, wherein the interface includes
an identification for a vehicle,
a current resale price for the vehicle, and
a diagnostic trouble code (DTC) currently associated with the vehicle, and an improved resale price for the vehicle under the condition that the DTC is removed.

17. The non-transitory computer-readable medium of claim 16, further comprising instructions, when executed by a computer device, make the computer device to:
responsive to receiving a user input, via the first interface, indicative of an intent to remove the DTC, output a second interface via the display, wherein the second interface includes
a repair cost to associated with a removal of the DTC; and
a list of service entities.

18. The non-transitory computer-readable medium of claim 17, further comprising instructions, when executed by a computer device, make the computer device to:
responsive to receiving a user selection for one of the service entities, schedule an appointment with the selected service entity; and
send the DTC to the service entity.

19. The non-transitory computer-readable medium of claim 17, wherein the repair cost includes parts cost and labor cost both of which are individually displayed.
